(19) United States
(12) Patent Application Publication
(10) Pub. No.: US 2023/0244780 A1
(43) Pub. Date: Aug. 3, 2023

(54) CONTROLLER FOR A VEHICLE, SYSTEM, METHOD, AND MOTOR VEHICLE COMPRISING SUCH A CONTROLLER

(71) Applicant: AUDI AG, Ingolstadt (DE)

(72) Inventors: Sebastian HANRIEDER, Untermaxfeld (DE); Florian HASELBECK, Landau (DE); Benjamin POPPINGA, Wettstetten (DE); Michael SCHLITTENBAUER, Pförring (DE); Johannes DUMLER, Hiendorf (DE); Torsten SCHÖN, Adelschlag (DE)

(73) Assignee: AUDI AG, Ingolstadt (DE)

(21) Appl. No.: 18/012,744

(22) PCT Filed: Apr. 19, 2021
(86) PCT No.: PCT/EP2021/060012

§ 371 Date: Dec. 23, 2022

(30) Foreign Application Priority Data
Jun. 25, 2020 (DE) 10 2020 116 714.8

(51) Int. Cl. G06F 21/53; G06F 9/455; G06F 9/445; G06N 20/00; G06F 8/65

(52) U.S. Cl. CPC G06F 21/53; G06F 9/45558; G06F 9/44521; G06N 20/00; G06F 8/65; G06F 2009/45579

(57) ABSTRACT

A system, a method, and a controller for a vehicle include a limited runtime environment within a virtual machine for at least one AI program by a computing platform of a computing device, and at least one specific program library for the AI program from outside of the limited runtime environment by a library managing unit. Specified vehicle sensor data is provided to the AI program by a data managing unit for a machine learning and/or classification process.

### CROSS REFERENCE TO RELATED APPLICATIONS

This application is a U.S. National Stage Application which claims the benefit under 35 U.S.C. § 371 of International Patent Application No. PCT/EP2021/060012 filed on Apr. 19, 2021, which claims priority benefit from German Patent Application No. 102020116714.8 filed on Jun. 25, 2020, the contents of each of which are incorporated herein by reference in their entireties.

### BACKGROUND

Described below is a control unit with a computing device to operate a computing platform for artificial intelligence to provide a runtime environment for at least one artificial intelligence program (AI program). The AI program to use predefined vehicle sensor data for machine learning and/or classification of the vehicle sensor data. The computing platform includes a library management unit to provide at least one predefined program library for the AI program.

Specifically in the automotive field, the use of artificial intelligence programs (AI programs), which may also be referred to as “machine learning” programs or algorithms, facilitates solutions to complex problems. In this context, the AI program may be taught by data, in particular vehicle sensor data, the AI program being able to automatically classify subsequent data after the teaching and therefore being able to make decisions by artificial intelligence.

Operating and assimilating these AI programs into a vehicle entail a very high level of complexity. Various criteria need to be met for a functionality of such a mechanism. An AI program requires an operational self-contained environment that provides it with the vehicle/sensor data required for operation, a storage location for model parameters, and suitable program libraries, that is software libraries. Execution of the AI program should also be monitored to restart the AI program if necessary.

US 2020/0097851 A1 discloses a method and a system of the type in question for carrying out machine learning methods. A computer-based platform is used for storing, cataloging and carrying out the machine learning methods, with binary definitions and metadata from models being stored in a store.

US 2019/0205667 A1 discloses a method, an apparatus and a system for machine learning for generating synthetic image data.

US 2019/0188800 A1 discloses a computing platform for controlling autonomous vehicles for the purpose of optimizing traffic characteristics.

A disadvantage of methods known hitherto is that a lack of standardization when assimilating AI programs into a vehicle means that synergies cannot be used completely and sustainably. As a result, redundant activities can arise during the operation and assimilation of these programs. Software libraries are sometimes assimilated multiple times, since they are each available only for one algorithm of an AI program. Furthermore, data are sent multiple times, since they are in each case likewise provided only for one algorithm of an AI program.

### SUMMARY

An aspect of the present invention is to provide a control unit for improved use of AI programs for a vehicle.

An aspect of the invention is to produce on a control unit a computing platform for an artificial intelligence program, or machine learning algorithms (or processes, or procedures, or methods), in which at least one AI program, including multiple AI programs, are operated in a respective adapted virtual environment or virtual machine, wherein a program or software library that all AI programs use is not installed in the virtual environments individually, but rather is provided for all of them centrally from outside of the virtual environments, with the result that only one copy or instance of this program or software library is stored and/or maintained in the control unit.

An aspect of the present invention also includes a control unit for a vehicle, the control unit including a computing device that comprises a computing platform for artificial intelligence. The computing device may be a data processing device that comprises a processor, a main memory and a nonvolatile memory. The computing platform may be a layer or level of the computing device that is in particular in the form of a hardware platform or software platform. The computing platform is adapted to provide a respective runtime environment for at least one artificial intelligence program (AI program), the AI program adapted to use predefined vehicle sensor data for machine learning and/or to classify the vehicle sensor data. The computing platform comprises a library management unit, the library management unit adapted to provide at least one predefined program library, or software library, for the AI program. The computing platform is further adapted to generate the runtime environment as a delimited runtime environment within a virtual machine, the predefined program library provided outside of the virtual machine, wherein the library management unit is adapted to provide the predefined program library to the AI program in the delimited runtime environment from outside the delimited runtime environment, and wherein the computing platform comprises a data management unit adapted to provide the predefined vehicle sensor data to the AI program in the delimited runtime environment for the purpose of machine learning and/or classification.

In other words, a computing device of the control unit may comprise a computing platform for artificial intelligence that may be in the form of an application layer in accordance with the OSI model. The computing platform may also comprise multiple software modules, in particular a library management unit (library handler) and a data management unit (data handler), that manage operation of an AI program. An AI program may be a computer program that may use artificial intelligence to analyze data, including vehicle sensor data, teaching a machine learning algorithm by predefined vehicle sensor data. The taught model parameters, or patterns, may be stored in the form of weighting data, for example. The taught AI program may then be used to classify vehicle sensor data to make decisions automatically, for example for autonomous driving.

The computing platform may generate a runtime environment for the at least one AI program, the runtime environment being generated as a delimited runtime environment. This means that a virtual machine, or a virtual environment, is generated in which the AI program is provided in a manner delimited from a runtime environment of the computing platform, which may be an operating system of the computing device, for example. This delimited runtime environment of the virtual machine may be adapted to meet the requirements of the AI program. By way of example, computing resources, environment variables or an operating system of the delimited runtime environment may be matched to the AI program.

The library management unit of the computing platform may manage program libraries for AI programs centrally, in particular a program library that is predefined for the AI program, the program libraries being able to be stored on a memory of the computing device, outside of the virtual machine. The library management unit may adapted incorporate the program library predefined for the AI program into the delimited runtime environment of the virtual machine. By way of example, the library management unit may make a virtual connection from the delimited runtime environment to a storage location of the predefined program library by incorporating (mounting) a storage location of the program library into a file system of the virtual machine, the program library being provided as a shared program library that may be dynamically linked to the AI program, in particular using a dynamic linker of the computing platform.

The predefined program library may therefore be provided from outside of the virtual machine, resulting in the advantage that the program library does not need to be stored in the virtual machine. In particular when there are multiple virtual machines operating a respective AI program, this is advantageous because AI programs often use identical program libraries and therefore the program library does not need to be provided redundantly, saving storage space. Moreover, an update for a program library and consequently for the AI program may therefore take place centrally, facilitating operation and maintenance of AI programs. Alternatively or additionally, the predefined program library may also be stored at multiple storage locations outside of the one or more virtual machines, the library management unit being able to manage the incorporation of the respective storage location into the virtual machine.

The data management unit of the computing platform may be a central data transmission management system of the computing platform that is able to control a communication between software modules of the computing platform, the vehicle bus and the virtual machine. The data management unit may determine which vehicle sensor data the AI program is able to access. This allows the virtual machine and therefore ultimately the AI program to access only the vehicle sensor data that are approved for them. To this end, the data management unit may request an authorization for the AI program and/or the virtual machine, for example, and use a virtual connection to transmit to the delimited runtime environment only vehicle sensor data for which the authorization exists. In particular, the data management unit may distribute the authorization for communication to the AI program and/or the virtual machine with the vehicle sensor data. Moreover, the data management unit may distribute the rights to multiple virtual machines individually.

The aspects of the invention result in the advantage that AI programs are able to be assimilated into a vehicle more conveniently. The platform architecture allows storage space to be saved, for example in regard to the provision of software libraries, and system security to be increased by way of the creation of virtual machines. Redundant activities can be reduced by using synergies.

Aspects of the present invention also include examples that result in additional advantages.

One example provides for the computing platform to comprise a hypervisor and for the delimited runtime environment, virtualized within the computing device as a virtual machine, to be coupled to a hardware environment of the computing device only indirectly via the hypervisor of the computing platform, in particular via the library management unit and the data management unit. In other words, the computing platform is an abstracting layer between at least the delimited runtime environment and the hardware environment of the computing device. That is, the delimited runtime environment does not have independent access to the computing device and therefore the vehicle sensor data from the bus. The hypervisor of the computing platform may allocate the computing resources of the computing device and the data, in particular the vehicle sensor data, to the respective delimited runtime environment, the hypervisor in particular being able to provide multiple delimited runtime environments independently of one another. For the purpose of allocating the vehicle sensor data, the hypervisor may receive from the data management unit the information regarding which vehicle sensor data are approved for which AI program. In other words, the hypervisor may obtain from the data management unit the “permission” for the vehicle sensor data to be provided to the delimited runtime environment. Similarly, the hypervisor may interact with the library management unit and provide the predefined program library, following agreement with the library management unit, to the AI program in the delimited runtime environment from outside the delimited runtime environment. Moreover, the hypervisor, the library management unit and the data management unit may be provided in the same runtime environment, that is to say on one level, but the hypervisor may also provide a separate virtual machine for the library management unit and/or the data management unit. The hypervisor may be in the form of a type 1 hypervisor or type 2 hypervisor and may therefore either sit directly on the hardware of the computing device or run on an operating system of the computing device and therefore serve as host system for the virtual machine. This example results in the advantage that the delimited runtime environment, in particular the AI program, does not have direct access to the hardware environment, allowing security for the control unit to be increased. By way of example, it is also possible to use AI programs from third parties without compromising security.

A further example provides for the computing platform to provide multiple delimited runtime environments containing a respective AI program, the library management unit being adapted to provide the predefined program library to the multiple delimited runtime environments by shared access. In other words, at least the predefined program library is provided centrally for all of the delimited runtime environments of multiple virtual machines for the respective AI program. It is therefore possible for the predefined program library not to be provided redundantly in each virtual machine, but rather storage space may be saved and synergies between different AI programs may be used. Many AI programs require similar or identical program libraries, this example being able to reduce redundant activities, since for example an update for the program library does not require the program library to be updated in each virtual machine, but rather the program library may be updated centrally once for all AI programs. Shared access means that the library management unit is able to make a virtual connection from each delimited runtime environment to the storage location of the predefined program library and may incorporate this program library into the AI program by a dynamic linker.

A further example provides for the data management unit to be further adapted to get weighting data and/or result data of the respective AI program from the respective delimited runtime environment and to provide them to a further AI program in a further delimited runtime environment and/or for the purpose of controlling a vehicle function. The AI program, which may be in the form of a machine learning algorithm, is able, for example during machine learning, to generate weighting data that may represent taught decisions of the AI program, for example. These weighting data may then be used by the AI program to classify further data, in particular vehicle sensor data, in order to obtain result data. In particular, the result data may comprise control instructions for a vehicle function. The weighting data and/or result data may be forwarded by the data management unit, for example as input into a further AI program of a further delimited runtime environment, and/or the result data may be placed onto a bus of the control unit by the data management unit, for example in order to be used as input data for a function of the vehicle. This example results in the advantage that the data cannot be sent from the AI program to a further AI program or used for controlling a vehicle function directly, but rather the provision and forwarding run via the data management unit. This allows control to be maintained over the vehicle sensor data by the computing platform, increasing security for the control unit.

A further example provides for the computing platform to comprise a hardware abstraction layer that is adapted to adapt the computing platform to suit hardware of the computing device of the control unit. In other words, the hardware abstraction layer is able to isolate the computing platform, in particular an operating system of the computing platform, from the hardware of the computing device. For example, only the hardware abstraction layer may access the hardware of the control unit, and software of the computing device, in particular the computing platform, is able to communicate with the hardware of the control unit only with the mediation of the hardware abstraction layer. This abstraction makes it easier to adapt the computing platform to suit different processor architectures of the computing device, since only the hardware abstraction layer needs to be changed. This results in the advantage that the computing platform is able to be flexibly adapted to suit a computing device or a control unit, since the hardware abstraction layer needs to be adapted accordingly.

A further example provides for the computing platform to comprise a problem identification unit that is adapted to check the classification of the vehicle sensor data by the AI program for the existence of a predefined classification condition and to store the vehicle sensor data for which the classification condition exists in a problem data memory. In other words, the problem identification unit is able to eliminate problematic vehicle sensor data that are not, or have a very low probability of being, categorized by the AI program and to store them in a problem data memory in order to be able to provide these vehicle sensor data for analysis or retraining later. The problem identification unit may be a software module of the computing platform. The classification condition may be for example a predefined threshold value that is able to indicate a quality of the identification by the AI program. By way of example, the classification condition may be that classification of the vehicle sensor data should take place with a certainty of above 80 percent. If vehicle sensor data are found below this classification condition, these vehicle sensor data may be separated from a process by the problem identification unit and stored in the problem data memory. Alternatively or additionally, the respective AI program is able to check the classification of the vehicle sensor data for the existence of the classification condition and to notify the problem identification unit if the classification condition exists, in order to store the relevant vehicle sensor data in the problem data memory. This example results in the advantage that later retraining of the AI program is able to be performed, which continuously improves the AI program and enhances its prediction capability.

A further example provides for the computing platform to comprise a communication unit that is adapted to receive an update for the AI program and/or a further AI program, in particular from a vehicle-external server, and to incorporate said update during a run time of the computing device and/or the delimited runtime environment. In other words, an update or an extension by a further AI program may be performed by the communication unit, during a run time of the computing device and/or the delimited runtime environment. The communication unit may be a software module. The communication unit may have a communication protocol that may comprise a data connection by way of WLAN, a mobile radio standard and/or Bluetooth, for example. This may then be used to receive the update data or program data. Connection during the run time may be performed using so-called “hot swapping”, or “hot plugging”. This may involve an interpreter incorporating the update for the AI program and/or the further AI program directly during the run time. This example results in the advantage that the control unit is able to be updated and adapted to suit new circumstances flexibly and quickly using the computing platform.

A further aspect of the invention relates to a system having a control unit according to one of the preceding exemplary examples and having a vehicle-external server, the vehicle-external server comprising a mirrored computing platform that is adapted to receive the vehicle sensor data from the problem data memory of the computing device of the control unit and to analyze said vehicle sensor data by a server-based AI program in accordance with supervised machine learning and to provide weighting data and/or result data of the analysis to the computing device of the control unit as an update. In other words, besides the control unit, the computing platform is also provided on a vehicle-external server that is able to receive the vehicle sensor data from the problem data memory of the computing device, the vehicle-external server being adapted to analyze the vehicle sensor data of the problem data memory by a server-based AI program. In particular, the vehicle sensor data from the problem data memory may be analyzed by supervised machine learning, and the result data from this analysis may be transmitted back to the control unit again. This aspect of the invention results in the advantage that “problem data” are able to be classified quickly and easily without needing to have direct access to the control unit, in particular to the AI program.

A method is also provided according to an aspect of the invention. The method comprises a computing platform of a computing device providing a delimited runtime environment within a virtual machine for at least one artificial intelligence program (AI program), wherein the AI program is machine-taught by predefined vehicle sensor data and/or wherein the AI program classifies the vehicle sensor data, a library management unit providing at least one predefined program library for the AI program from outside the delimited runtime environment, and a data management unit providing the predefined vehicle sensor data to the AI program for the purpose of machine learning and/or classification. This results in the same advantages and variation options as for the control unit.

An aspect of the invention also includes developments of the method according to examples of the invention that comprise features as have already been described in connection with the developments of the control unit according to examples of the invention. For this reason, the applicable developments of the method according to aspects of the invention are not described again here.

A further aspect of the invention relates to a motor vehicle having a control unit according to one of the preceding examples. The motor vehicle according to the invention is in the form of a motor car, in particular in the form of an automobile or truck, or in the form of a passenger bus or motorcycle.

Another aspect of the invention also includes the control apparatus for the motor vehicle. The control apparatus may comprise a data processing apparatus or a processor device that is configured to perform an example of the method according to the invention. To this end, the processor device may comprise at least one microprocessor and/or at least one microcontroller and/or at least one FPGA (field programmable gate array) and/or at least one DSP (digital signal processor). In addition, the processor device may comprise program code that is configured to perform the example of the method according to the invention when executed by the processor device. The program code may be stored in a data memory of the processor device.

Aspects of the invention also include the combinations of the features of the examples described.

### BRIEF DESCRIPTION OF THE DRAWINGS

Exemplary examples of the invention are described below. In this regard,

FIG. 1 shows a schematic representation of a system having a control unit and a vehicle-external server according to an illustrative example; and

FIG. 2 shows a schematic method chart according to an illustrative example.

### DETAILED DESCRIPTION

The exemplary examples explained below are examples of the invention. In the exemplary examples, the described components of the examples each constitute individual features of the invention that should be considered independently of one another and that each also develop the invention independently of one another. Therefore, the disclosure is also intended to encompass combinations of the features of the examples other than the combinations presented. Furthermore, the examples described can also be supplemented by further features of the invention from among those already described.

In the figures, identical reference signs in each case denote functionally identical elements.

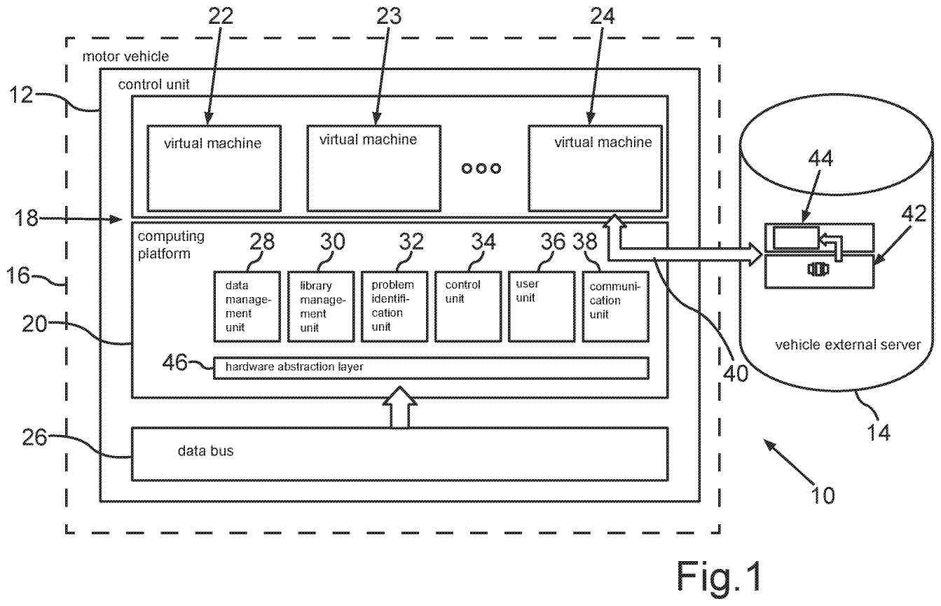

FIG. 1 shows a system 10 having a control unit 12 and a vehicle-external server 14 according to an illustrative example. The control unit 12 may be provided in a motor vehicle 16, this being indicated only schematically in FIG. 1.

The control unit 12 may comprise a computing device 18 that is adapted to operate a computing platform 20 for artificial intelligence. For this purpose, the computing device 18 may comprise one or more processors, main memory, a nonvolatile memory and an operating system, which are not shown in this figure. The computing platform may be in the form of a hypervisor, which is operated as a type 2 hypervisor, for example, in the operating system of the computing device 18. The computing platform 20 may be adapted to generate one or more virtual machines 22, 23, 24 having a respectively delimited runtime environment, on each of which an artificial intelligence program (AI program) is able to be operated. The AI programs of the respective virtual machines 22, 23, 24 may be adapted to use the vehicle sensor data, in particular to use predefined vehicle sensor data for the AI program, for machine learning and/or to classify the vehicle sensor data. An AI program may comprise an algorithm for machine learning, for example, in particular a neural network, that is able to analyze data, in particular vehicle sensor data, and, on the basis of the analysis, is able to recognize a pattern in data. That is, the AI program is able to classify vehicle sensor data for the existence of a pattern. By way of example, the virtual machine 22 may operate an AI program for automatic image recognition, the virtual machine 23 may operate an AI program for voice recognition and the virtual machine 24 may operate an AI program for autonomous driving.

To get the vehicle sensor data, the control unit 12 may be connected to a data bus 26 of the motor vehicle 16, vehicle sensor data being able to comprise audio data from a microphone, data from distance sensors and camera data, for example. To correctly assign the vehicle sensor data to the suitable AI program, the computing platform 20 may comprise one or more units, which may be provided as software modules. For example, the computing platform 20 may comprise a data management unit 28 that is able to control which virtual machine 22, 23, 24 is permitted to access which vehicle sensor data. The virtual machines 22, 23, 24 and the associated AI programs are therefore able to access only the sensor/bus data that are approved for them, which allows security to be increased. By way of example, it is also possible for the data management unit 28 to manage the data that come from the AI programs. By way of example, the data management unit 28 may get weighting data and/or result data from the AI program of the delimited runtime environment of the virtual machine 22 and either make them available to a further AI program, for example the AI program in the delimited runtime environment of the virtual machine 23, or provide the result data to the data bus 26 for the purpose of controlling a vehicle function. For example, the data transmission does not take place between the AI program and the data bus 26 directly, but rather is monitored by the data management unit 28. It is therefore possible to ensure at all times that an AI program from third parties is not also able to access unauthorized vehicle sensor data.

Since the AI programs of the respective virtual machines often use identical program libraries, the computing platform 20 may comprise a library management unit 30 that is able to control access to program libraries. By way of example, the AI programs of the virtual machines 22 and 23 may require a predefined program library. So that this predefined program library does not need to be copied to each of the virtual machines 22, 23, the library management unit 30 may be adapted to make a connection to a storage location outside the respectively delimited runtime environment of the virtual machines. That is, the storage location of the predefined program library is provided in a data structure of the computing device 18 outside the virtual machines 22, 23, 24. The library management unit 30 is therefore able to hold the predefined program library once outside the delimited runtime environments, allowing storage space to be saved. The predefined program library may therefore be provided centrally by shared access.

Additionally, the computing platform 20 may comprise a problem identification unit 32 that is able to provide a so-called “corner case” mechanism for the AI programs. Should an AI program decide that current vehicle sensor data cannot be categorized correctly, or that a current situation cannot be classified with a high degree of certainty, then the problem identification unit 32 is able to store the vehicle sensor data of these virtual machines 22, 23, 24 in a problem data memory (not shown), which may be located outside the respective virtual machine 22, 23, 24, for later retraining. By way of example, the problem identification unit 32 may have a classification condition for this purpose, and a classification of an AI program is checked for whether this classification condition exists for the classification. If this is the case, the relevant vehicle sensor data can be stored in the problem data memory. The classification condition may be a threshold value, for example, in particular a value regarding the probability with which the vehicle sensor data were classified by the AI program.

Furthermore, the computing platform 20 may comprise a control unit 34 that, by way of example, may be adapted to generate the virtual machines 22, 23, 24 and to provide system resources of the computing device 18 for the respective virtual machine 22, 23, 24, the system resources being tailored specifically to the requirements of the respective AI program. By way of example, the control unit 34 may also monitor the virtual machines 22, 23, 24 in order to restart the virtual machines 22, 23, 24 if necessary. Preferably, there may also be provision for a graphical user interface by way of which the computer platform 20 and the virtual machines 22, 23, 24 may be controlled.

Particularly, the computing platform 20 may also comprise a user unit 36 that is able to manage user-specific data for using the AI programs. By way of example, there may be provision for different weighting data for the AI programs of the virtual machines 22, 23, 24 for different users, in particular of the motor vehicle 16, said data being able to be managed by the user unit 36 and loaded when the respective user is recognized.

Additionally, the computing platform 20 may comprise a communication unit 38 that is able to provide a data connection 40, in particular a data connection 40 to the vehicle-external server 14. By way of example, the communication unit 38 may be adapted to get an update for the AI program or a further AI program for one of the virtual machines 22, 23, 24, for example for the virtual machine 24, and to incorporate said update or further AI program during a run time of the computing device 18. In this regard, the virtual machine 24 may have hot plug-in capability. This means that it is able to be updated during a run time of the computing device 18 without having to perform a restart. This allows a new AI program to be incorporated variably and quickly.

In addition, the communication unit 38 may be adapted to load the vehicle sensor data that were identified as problematic by the problem identification unit 32 from the problem data memory and to send them to the vehicle-external server 14. For example, the vehicle-external server 14 may comprise a mirrored computing platform 42, which may be identical to the computing platform 20 on the control unit 12. By way of example, a server-based AI program may be operated on the mirrored computing platform 42 within a further virtual machine 44, which may be used to analyze the vehicle sensor data from the problem data memory and to teach the AI program externally to the vehicle. Subsequently, the thus taught data of the virtual machine 44 may be transmitted back to the AI program of the virtual machine 24 by way of the communication unit 38.

Particularly, the computing platform 20 may comprise a hardware abstraction layer 46 that is adapted to adapt the computing platform 20 to suit hardware of the computing device 18. That is, a layer of the operating system of the computing device 18 separates the hardware of the computing device 18 from the operating system core (kernel) and the remainder of the software, in particular the AI programs and the software modules of the computing platform 20. This has the advantage that the computing platform is able to be adapted variably to suit different control units and/or vehicle-external servers (backend) having different operating systems.

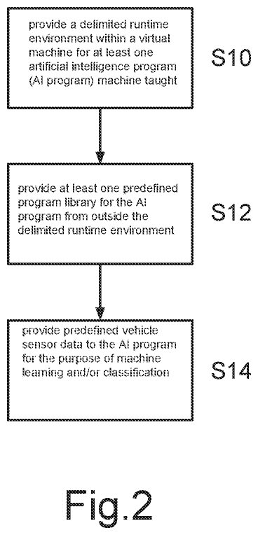

FIG. 2 shows an illustrative flowchart for a method for machine learning and/or classification by an AI program. The method comprises, as step S10, a computing platform 20 of a computing device 18 providing a delimited runtime environment within a virtual machine 22, 23, 24 for at least one artificial intelligence program (AI program), the AI program being machine taught by predefined vehicle sensor data, and/or the AI program classifying the vehicle sensor data. As step S12, the method comprises a library management unit 30 providing at least one predefined program library for the AI program from outside the delimited runtime environment, and as a step S14, the method comprises a data management unit 28 providing the predefined vehicle sensor data to the AI program for the purpose of machine learning and/or classification.

In another illustrative example, one aspect consists in a machine learning platform (computing platform 20) providing a separate virtual environment, that is to say a virtual machine 22, 23, 24, for each machine learning algorithm (AI program). If required, multiple AI programs may also be assimilated in the same virtual machine. This virtual, delimited runtime environment may be adapted to suit the respective machine learning algorithm. The software libraries required, that is to say the predefined program library, and the vehicle sensor data provided by the data management unit 28 may be provided. A configuration of the virtual machines 22, 23, 24 allows the software libraries to be installed on the control unit 12 only once and to be subsequently able to be used by multiple machine learning algorithms without the latter being located in the same virtual machine. Additionally, this mechanism can ensure that the machine learning algorithm, or the respective virtual machine 22, 23, 24, is able to access only the vehicle sensor data approved for it in its delimited runtime environment. This affords greater security when assimilating machine learning algorithms from third parties.

In the machine learning platform 20 itself, software modules 28, 30, 32, 34, 36, 38 look after the provision and management of the machine learning algorithms. In addition, the platform 20 monitors the machine learning algorithms. If an algorithm no longer reacts, it may be restarted or shut down completely by way of the platform 20. The platform 20 may contain an update manager (communication unit 38) that is able to replace and/or update existing modules and/or machine learning algorithms, or is able to assimilate new modules and/or machine learning algorithms. A backend connection (data connection 40) can thus be used to conveniently load new or newly trained algorithms onto the control unit 12 of the motor vehicle 16, or to update said algorithms.

The machine learning platform 20 may likewise be installed on a backend (vehicle-external server 14) in order to train the algorithms with new vehicle sensor data/swarm data there and then to subsequently distribute said data to the motor vehicle 16 or further vehicles again. A GUI interface can be used to conveniently assimilate new machine learning algorithms into the platform 20. In addition, it can be used to display the current outputs from the virtual machines 22, 23, 24.

The smart platform architecture allows storage space to be saved, for example in regard to the provision of software libraries, and system security to be increased by way of the creation of virtual machines 22, 23, 24. Redundant activities can be reduced and synergies used. The installation of the machine learning platform 20 in the backend 14 likewise allows machine learning algorithms to be trained there, for example by swarm data, and subsequently sent to the machine learning platform 20 in the motor vehicle in order to assimilate these new/improved algorithms there. It is therefore possible to create a self-contained ecosystem. If the vehicles or networking architectures are different, just the machine learning platform 20 itself may be varied. The machine learning algorithms may therefore always be used without alteration.

For example, the machine learning platform 20 may be assimilated on one or more control units 12/backends 14. The machine learning algorithms are assimilated into separate virtual machines 22, 23, 24. These delimited runtime environments of the virtual machines 22, 23, 24 may be adapted specifically according to the requirements of the respective machine learning algorithm during the run time. For example the current weights of the algorithm are stored in them. The virtual machines 22, 23, 24 are separate from one another. The machine learning algorithms are able to access the machine learning software libraries without needing to copy them to the environment. It is therefore possible for multiple machine learning algorithms from separate virtual environments to access the same software library. Synergies may therefore be used between the different machine learning algorithms.

The communication between the machine learning platform, a sensor/bus system (data bus 26) and the virtual machines 22, 23, 24 may be effected by way of a central data transmission management system (data management unit 28). This data transmission management system 28 may be located in the machine learning platform 20 and is able to control which subscriber is permitted to access which data. This allows the virtual machines 22, 23, 24 and therefore ultimately the machine learning algorithms to access only the vehicle sensor/bus data that are approved for them. The results of the machine learning algorithms may likewise be put onto the bus in order to possibly be used as input data for a function or a further machine learning algorithm. The machine learning platform 20, as central instance, controls the operation and the monitoring of the machine learning algorithms.

The machine learning platform 20 is used to collect the vehicle sensor data/bus data and to put them onto the data transmission management system (data management unit 28). In addition, the machine learning platform 20 is able to look after the management, for example version management, and provision of required machine learning software libraries. Furthermore, it is able to provide a so-called “corner case” mechanism for machine learning algorithms. Should an algorithm decide that it cannot categorize the current vehicle sensor data/bus data correctly or cannot classify the current situation with a high degree of certainty, then it may use a problem identification unit 32 to store the vehicle sensor data in a problem data memory for later retraining. This retraining of the algorithm may take place both in the vehicle 16 and in the backend 14 after a prior transmission of the vehicle sensor data. The machine learning algorithm can therefore continuously improve and can enhance its prediction capability. A developer of the machine learning algorithm is also able to use these corner case data for further development and analysis.

A platform-internal update manager (communication unit 38) may be used to update the algorithms that are in the vehicle 16 by way of the backend 14, or new machine learning algorithms may be assimilated. A user management module (user unit 36) may be used to store user-specific parameters and/or data and to interchange these with the virtual machines 22, 23, 24 or the backend 14. An abstraction layer (hardware abstraction layer 46) assimilated in the machine learning platform 20 allows the machine learning platform 20 to be used on different control units/backends having different operating systems.

Overall, the examples show how the invention is able to provide a machine learning platform.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-10. (canceled)

11. A control unit for a vehicle, the control unit comprising:
a computing device comprising:
a computing platform for artificial intelligence, the computing platform to provide a respective runtime environment for at least one artificial intelligence program (AI program) to classify predefined vehicle sensor data,
the computing platform comprising:
a library management unit to provide at least one predefined program library for the AI program, the computing platform to generate the runtime environment as a delimited runtime environment within a virtual machine, the predefined program library being outside of the virtual machine, the library management unit to provide the predefined program library to the AI program in the delimited runtime environment from outside of the delimited runtime environment; and
a data management unit to provide the predefined vehicle sensor data to the AI program in the delimited runtime environment for the purpose of classification;
wherein:
the computing platform to provide multiple delimited runtime environments including a respective AI program, the library management unit to provide the predefined program library to the multiple delimited runtime environments by shared access;
the data management unit to obtain result data of the classification of the respective AI program from the respective delimited runtime environment and to provide the obtained result data to control a vehicle function.

12. The control unit as claimed in claim 11, wherein the computing platform comprises a hypervisor, and the delimited runtime environment, virtualized within the computing device as a virtual machine, is coupled to a hardware environment of the computing device only indirectly via the hypervisor of the computing platform.

13. The control unit as claimed in claim 11, wherein the data management unit further designed to obtain result data of the classification of the respective AI program from the respective delimited runtime environment and to provide said data to a further AI program in a further delimited runtime environment.

14. The control unit as claimed in claim 12, wherein the data management unit further designed to obtain result data of the classification of the respective AI program from the respective delimited runtime environment and to provide said data to a further AI program in a further delimited runtime environment.

15. The control unit as claimed in claim 11, wherein the computing platform comprises a hardware abstraction layer to adapt the computing platform to suit hardware of the computing device of the control unit.

16. The control unit as claimed in claim 12, wherein the computing platform comprises a hardware abstraction layer to adapt the computing platform to suit hardware of the computing device of the control unit.

17. The control unit as claimed in claim 13, wherein the computing platform comprises a hardware abstraction layer to adapt the computing platform to suit hardware of the computing device of the control unit.

18. The control unit as claimed in claim 14, wherein the computing platform comprises a hardware abstraction layer to adapt the computing platform to hardware of the computing device of the control unit.

19. The control unit as claimed in claim 11, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

20. The control unit as claimed in claim 12, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

21. The control unit as claimed in claim 13, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

22. The control unit as claimed in claim 14, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

23. The control unit as claimed in claim 15, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

24. The control unit as claimed in claim 16, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

25. The control unit as claimed in claim 17, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

26. The control unit as claimed in claim 18, wherein the computing platform comprises a problem identification unit to check the classification of the vehicle sensor data by the AI program for the existence of a predefined classification condition and to store the vehicle sensor data for which the classification condition exists in a problem data memory, the classification condition indicating a quality of the identification by the AI program.

27. The control unit as claimed in claim 11, wherein the computing platform comprises a communication unit to receive an update for the AI program and/or a further AI program, from a vehicle-external server, and to incorporate said update during a run time of the computing device and/or the delimited runtime environment.

28. A system comprising:
a control unit as claimed in claim 11; and
a vehicle-external server comprising a mirrored computing platform to receive the vehicle sensor data from a problem data memory of the computing device of the control unit and to retrain the AI program by a server-based AI program in accordance with supervised machine learning and to provide weighting data of the retraining to the computing device of the control unit as an update.

29. A motor vehicle comprising:
a control unit comprising:
a computing device comprising:
a computing platform for artificial intelligence, the computing platform to provide a respective runtime environment for at least one artificial intelligence program (AI program) to classify predefined vehicle sensor data,
the computing platform comprising:
a library management unit to provide at least one predefined program library for the AI program, the computing platform to generate the runtime environment as a delimited runtime environment within a virtual machine, the predefined program library being outside of the virtual machine, the library management unit to provide the predefined program library to the AI program in the delimited runtime environment from outside of the delimited runtime environment; and
a data management unit to provide the predefined vehicle sensor data to the AI program in the delimited runtime environment for the purpose of classification;
wherein:
the computing platform to provide multiple delimited runtime environments including a respective AI program, the library management unit to provide the predefined program library to the multiple delimited runtime environments by shared access;
the data management unit to obtain result data of the classification of the respective AI program from the respective delimited runtime environment and to provide the obtained result data to control a vehicle function.

30. A motor vehicle as claimed in claim 29, wherein the computing platform comprises a hypervisor, and the delimited runtime environment, virtualized within the computing device as a virtual machine, is coupled to a hardware environment of the computing device only indirectly via the hypervisor of the computing platform.
